(19) United States
(12) Patent Application Publication
(10) Pub. No.: US 2019/0179352 A1
(43) Pub. Date: Jun. 13, 2019

(54) REGULATOR CIRCUIT AND SEMICONDUCTOR DEVICE, AND POWER SUPPLY

(71) Applicant: Kohei SAKURAI, Atsugi-shi (JP)

(72) Inventor: Kohei SAKURAI, Atsugi-shi (JP)

(73) Assignee: MITSUMI ELECTRIC CO., LTD., Tokyo (JP)

(21) Appl. No.: 16/212,491

(22) Filed: Dec. 6, 2018

(30) Foreign Application Priority Data
Dec. 12, 2017 (JP) 2017-237341

(51) Int. Cl. G05F 1/575; G05F 1/565

(52) U.S. Cl. CPC G05F 1/575; G05F 1/565

(57) ABSTRACT

A regulator circuit includes an output controlling transistor and a controller circuit. The output controlling transistor is connected between a voltage input terminal and an output terminal. The controller circuit includes an error amplifier circuit which controls the output controlling transistor according to an output feedback voltage. The error amplifier circuit includes a differential input stage, an output stage and a current increasing/decreasing circuit. The differential input stage includes input transistors and a current source. The output stage includes a current source and a transistor connected in series with the current source and amplifies a potential at one output node of the differential input stage. The current increasing/decreasing circuit includes an element having a temperature characteristic, and increases or decreases a current of the differential input stage or the current of the output stage according to the temperature characteristic.

### CROSS REFERENCE TO RELATED APPLICATION

This application is based upon and claims the benefit of priority under 35 USC 119 of Japanese Patent Application No. 2017-237341 filed on Dec. 12, 2017, the entire disclosure of which, including the description, claims, drawings and abstract, is incorporated herein by reference in its entirety.

### BACKGROUND OF THE INVENTION

### 1. Field of the Invention

The present invention relates to a regulator circuit that outputs a predetermined constant voltage based on a power supply voltage. For example, the present invention relates to a technique useful for semiconductor integrated circuits (regulator ICs) of voltage regulators such as series regulators.

### 2. Description of Related Art

Series regulators are a type of power supply that outputs a desired DC voltage by controlling a transistor disposed between a DC voltage input terminal and an output terminal. For example, one of such regulators is configured as a regulator circuit that includes an output controlling transistor composed of a MOS transistor, an error amplifier that controls the output controlling transistor according to a feedback voltage of an output voltage, and a phase compensator circuit that secures a phase margin (e.g. see JP 2003-177829A). Such a regulator circuit is typically configured as a semiconductor integrated circuit or a regulator IC in which the output controlling transistor and the error amplifier for controlling the transistor are incorporated.

In recent years, IoT techniques have been rapidly become popular, and an increasing number of various IoT-related sensors have been provided. IoT-related sensors and network devices with IoT-related sensors are often battery-driven products with a built-in regulator circuit. In terms of battery life, there is a need for regulator circuits with ultra-low power consumption. To achieve ultra-low power consumption, it is effective to employ a CMOS circuit and to drive a transistor in the circuit at a minute electric current. The ultra-low power consumption of a regulator circuit may also be achieved by intermittent operation. However, since intermittent operation generates a noise, non-intermittent operation is required for regulator circuits for the above-described use.

It has been known that the off-state current of a MOS transistor exponentially increases at high temperature. The environmental temperature affects the transistor of the error amplifier that is driven at a minute current, and the decreased phase margin of the control loop may sometimes cause oscillation of the regulator circuit, which results in ringing of the output voltage.

Specifically, in a conventional regulator circuit with no measure for temperature, the bias current (amplifier current) of an error amplifier decreases with an increase of the environmental temperature (chip temperature) as illustrated by the dashed line A in FIG. 3A, and the phase margin decreases accordingly as illustrated by the dashed line A in FIG. 3B.

In order to avoid an occurrence of oscillation and an increase of an overshoot at a rise of the output voltage or an undershoot at a fall of the output voltage, an invention relating to a voltage regulator has been proposed, in which capacitor elements and a switching element are disposed in a phase compensator circuit, and the active capacitor element is switched according to the detected temperature to change the phase margin so that the circuit is less likely to cause oscillation (e.g. see JP 2014-59628A).

However, since the voltage regulator IC of JP 2014-59628A changes the phase margin by switching the capacitor element, it can change the phase margin only in a stepwise manner according to the temperature but not in a continuous manner. Further, another problem is that the switching of the capacitor element makes the operation of the circuit instable and generates a noise. JP 2003-177829A discloses neither a problem of the phase margin being decreased along with a change of the environmental temperature nor any means for solving the problem.

### SUMMARY OF THE INVENTION

The present invention has been made in view of the above-described problems, and an object thereof is to provide a regulator circuit that is less likely to cause oscillation of the circuit or ringing of the output voltage even when the environmental temperature changes.

To achieve at least one of the abovementioned objects, according to an aspect of the present invention, a regulator circuit, includes:

an output controlling transistor which is connected between a voltage input terminal to which a DC voltage is input and an output terminal; and

a controller circuit comprising an error amplifier circuit which controls the output controlling transistor according to an output feedback voltage,

wherein the error amplifier circuit includes:
a differential input stage which includes a pair of input transistors and a current source for supplying a current to the input transistors;
an output stage which includes a current source and a transistor connected in series with the current source and which amplifies a potential at one output node of the differential input stage; and
a current increasing/decreasing circuit which increases or decreases a current of the differential input stage or a current of the output stage, and

wherein the current increasing/decreasing circuit includes an element having a temperature characteristic, and increases or decreases the current of the differential input stage or the current of the output stage according to the temperature characteristic of the element.

The regulator circuit having the above-described configuration can shift the extremum of the gain of the differential input stage or the output stage to a higher or lower frequency by increasing/decreasing the current of the differential input stage or the output stage in response to a change of the environmental temperature (chip temperature). This can reduce the occurrence of oscillation of the circuit or ringing of the output voltage.

Preferably, the element having the temperature characteristic is constituted by a MOS transistor having a ratio of gate width to gate length at least 10 times greater than a MOS transistor of the error amplifier circuit.

In this configuration, the MOS transistor with short gate length and long gate width has an off-state current at high temperature of greater than the off-state current of normal MOS transistors of the circuit. Therefore, the regulator circuit can increase the bias current of the differential input stage or the operation current of the output stage. This can improve the phase margin at high temperature of the error amplifier without changing the constant of the elements of the phase compensator circuit and can thereby reduce the occurrence of oscillation.

Preferably, the element having the temperature characteristic is constituted by a first conductive-type MOS transistor with a gate terminal and a source terminal connected to each other,

wherein the current increasing/decreasing circuit includes:
a second type-conductive MOS transistor which is connected in series with the first conductive-type MOS transistor; and
a MOS transistor which is connected with the second conductive-type transistor in a current mirror manner to flow a mirrored current proportional to an element size, and

wherein the MOS transistor which flows the mirrored current is connected in parallel to the current source of the differential input stage so as to increase/decrease the current of the differential input stage.

In this configuration, the regulator circuit includes a current mirror circuit that increases/decreases the bias current of the differential input stage according to the off-state current of the MOS transistor as the temperature detector element. The regulator circuit can increase/decrease the bias current of the differential input stage by using the current that corresponds to the mirror ratio. This can improve the phase margin of the error amplifier more suitably tailored to the circuit and thereby reduce the occurrence of oscillation.

Preferably, the error amplifier circuit further includes a voltage amplifier stage which amplifies a differential output of the differential input stage, and

wherein the output stage is connected in such a manner to amplify a potential at one output node of the voltage amplifier stage.

In this configuration, the error amplifier (error amplifier circuit) includes the voltage amplifier stage between the differential input stage and the output stage. This can increase the gain of the overall amplifier, and the regulator circuit can increase/decrease the bias current according to the increased gain. This can improve the phase margin of the error amplifier and thereby reduce the occurrence of oscillation.

Preferably, the MOS transistor of the element having the temperature characteristic is connected in parallel to the current source of the differential input stage or the current source of the output stage so as to increase/decrease the current of the differential input stage or the current of the output stage.

In this configuration, the current increasing/decreasing circuit for shifting the extremum frequency of the gain of the differential input stage or the output stage can be composed of only the MOS transistor as the temperature detector element. This allows improvement of the phase margin of the error amplifier only by adding a simple circuit and can thereby reduce the occurrence of oscillation.

The present invention is advantageous in that it can provide a regulator circuit that is less likely to cause oscillation of the circuit or ringing of the output voltage even when the environmental temperature changes.

### BRIEF DESCRIPTION OF THE DRAWINGS

The advantages and features provided by one or more embodiments of the invention will become more fully understood from the detailed description given hereinbelow and the appended drawings which are given by way of illustration only, and thus are not intended as a definition of the limits of the present invention, and wherein:

FIG. 1 is a circuit configuration view of a series regulator IC according to an embodiment of the present invention;

FIG. 2 is a circuit diagram of a specific circuit example of the regulator IC according to the embodiment in FIG, 1;

FIG. 3A is a characteristic chart illustrating the relationship between temperature and bias current of an error amplifier (amplifier current) when a current increasing/decreasing circuit of the error amplifier is present or absent;

FIG. 3B is a characteristic chart illustrating the relationship between temperature and phase margin when the current increasing/decreasing circuit is present or absent;

FIG. 4A is a Bode diagram illustrating the frequency characteristic of the gain of the error amplifier when the current increasing/decreasing circuit of the error amplifier is present;

FIG. 4B is a Bode diagram illustrating the frequency characteristic of the gain of the error amplifier when the current increasing/decreasing circuit is absent;

FIG. 5A is a Bode diagram illustrating the frequency characteristic of the phase when the current increasing/decreasing circuit of the error amplifier is present;

FIG. 5B is a Bode diagram illustrating the frequency characteristic of the phase when the current increasing/decreasing circuit is absent;

FIG. 6 is a circuit configuration diagram of the regulator circuit according to a first variation, illustrating an example configuration thereof;

FIG. 7 is a circuit configuration diagram of the regulator circuit according to a second variation, illustrating an example configuration thereof;

FIG. 8 is a circuit configuration diagram of the regulator circuit according to a third variation, illustrating an example configuration thereof; and

FIG. 9 is a characteristic chart illustrating the relationship between temperature and bias current of the error amplifier in the regulator circuit according to the third variation when the current increasing/decreasing circuit is present or absent.

### DETAILED DESCRIPTION OF THE PREFERRED EMBODIMENT

Hereinafter, a preferred embodiment of the present invention will be described based on the drawings.

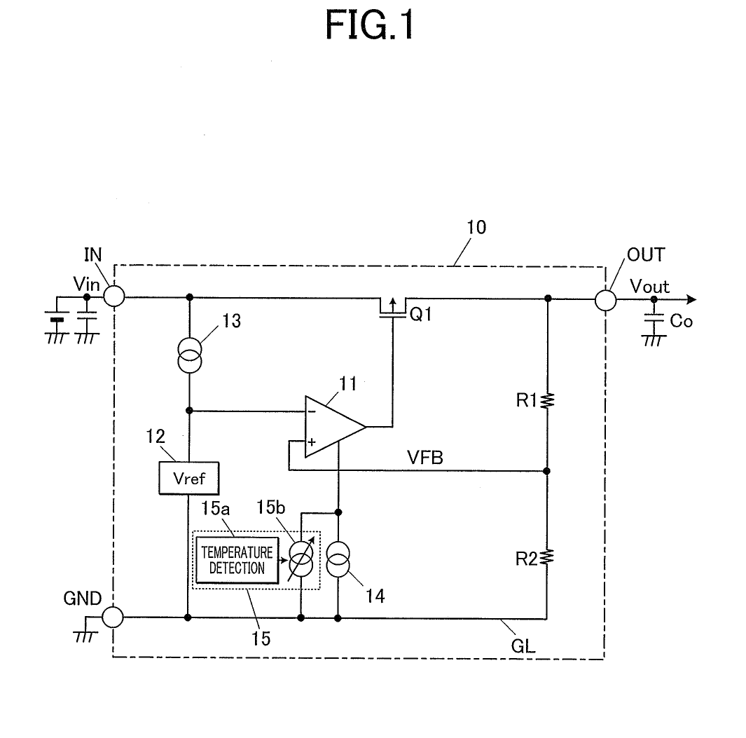

FIG. 1 illustrates a series regulator as a DC power supply according to an embodiment of the present invention. In FIG. 1, the portion enclosed by the dashed-dotted line is formed as a semiconductor integrated circuit (regulator IC) 10 on a semiconductor chip such as single-crystal silicon, and a capacitor Co is connected to an output terminal OUT of the regulator IC 10. The series regulator functions as a DC power supply that supplies a stable DC voltage. As used herein, the term “regulator circuit” encompasses both the regulator IC 10 and a DC power supply using the regulator IC 10. The regulator IC 10 or the regulator IC 10 along with the capacitor Co may be incorporated in a single package as a semiconductor device.

As illustrated in FIG. 1, the regulator IC 10 of the embodiment includes a voltage controlling transistor Q1 that is connected between a voltage input terminal IN to which a DC voltage Vᵢₙ is applied and an output terminal OUT. The voltage controlling transistor Q1 is constituted by a p-channel MOS transistor (insulated gate field effect transistor) and controlled by an error amplifier (error amplifier circuit) 11. The regulator IC 10 further includes a breeder resistors R1, R2 that is connected between the output terminal OUT and a ground line GL connected to a ground terminal GND. The breeder resistors R1, R2 divide an output voltage Vₒᵤₜ to generate a feedback voltage V_{FB} to be applied to the error amplifier 11.

In the regulator IC 10 of the embodiment, the voltage V_{FB} divided by the breeder resistors R1, R2 is fed back to a non-inverting input terminal of the error amplifier 11 that serves as the error amplifier circuit for controlling the gate terminal of the voltage controlling transistor Q1. The error amplifier 11 thus controls the voltage controlling transistor Q1 according to the potential difference between the output feedback voltage V_{FB} and a predetermined reference voltage V_{ref} so as to maintain the output voltage Vₒᵤₜ at a desired potential. Although not shown in FIG. 1, the error amplifier 11 includes a phase compensator circuit for preventing an occurrence of oscillation.

The regulator IC 10 of the embodiment further includes a standard voltage circuit 12 that generates the reference voltage V_{ref} to be applied to an inverting input terminal of the error amplifier 11, a constant current sources 13, 14 that supply a bias current respectively to the error amplifier 11 and the standard voltage circuit 12, and a current increasing/decreasing circuit 15 that increases/decreases the bias current of the output controlling transistor Q1 according to the chip temperature. Although not shown in the figure, the regulator IC 10 further includes a thermal shutdown circuit (TSD) that stops operation of the error amplifier 11 to turn off the output controlling transistor Q1 when the chip temperature reaches a predetermined temperature or more.

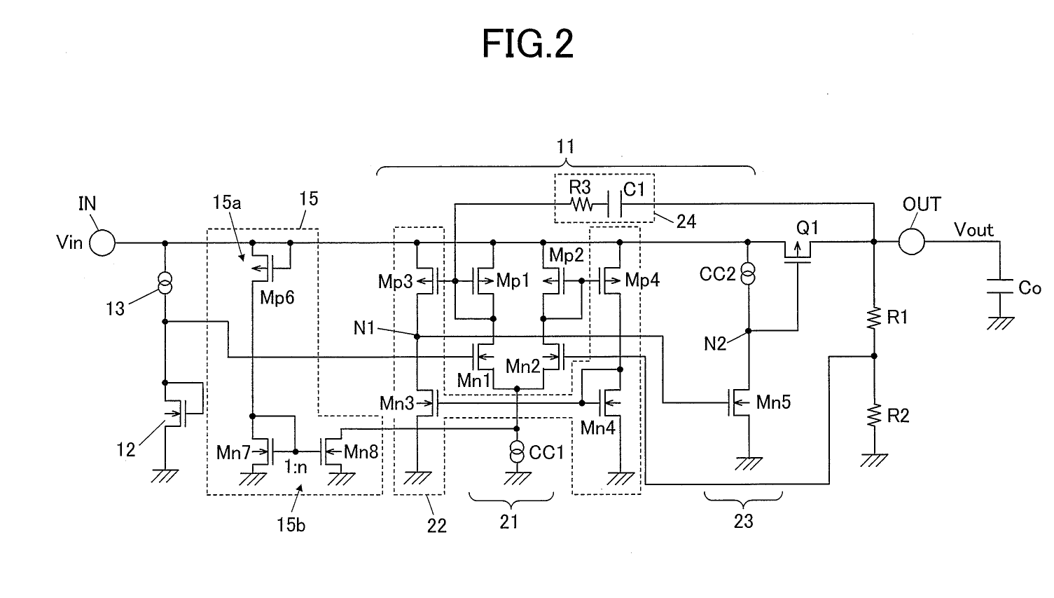

The standard voltage circuit 12 can be constituted by a resistor and a Zener diode connected in series, a MOS transistor with the gate terminal and the drain terminal connected to each other (see FIG. 2) and the like. The current increasing/decreasing circuit 15 includes a temperature detector element or a temperature detector circuit 15a that detects the chip temperature, a variable current source 15b that is connected in parallel to the constant current source 14 and that changes the current according to the voltage applied from the temperature detector circuit 15a.

Although not shown in the figure, the regulator IC 10 may have (i) a function of controlling supply and cut off of the bias current to the error amplifier 11 according to a control signal input from an external microcomputer (CPU) and/or (ii) a function of cramping the output current when the error amplifier 11 is about to decrease the gate voltage to supply more current to the output controlling transistor Q1 in response to an abnormality of a load or the like that increases the output current and decreases the output voltage Vₒᵤₜ accordingly.

Next, a specific circuit example of the regulator IC in FIG. 1 will be described with FIG. 2.

The error amplifier 11 of the example in FIG. 2 includes a differential input stage 21 that amplifies the difference between two input voltages, a voltage amplifier stage 22 that amplifies the differential output of the differential input stage 21, an output stage 23 that outputs the voltage amplified by the voltage amplifier stage 22 at low impedance, and the like.

The differential input stage 21 includes a pair of input transistors Mn1, Mn2, which are n-channel MOS transistors with common sources connected to each other, load transistors Mp1, Mp2, which are p-channel MOS transistors respectively connected to the drains of the input transistors Mn1, Mn2, a constant current source CC1 that is connected between the common sources of the input transistors Mn1, Mn2 and a ground point. The differential input stage 21 is thus configured as a CMOS circuit.

Gates of the load transistors Mp1, Mp2 of the differential input stage 21 are connected to respective drains so that they function as current-voltage converter elements. The voltage amplifier stage 22 includes p-channel MOS transistors Mp3, Mp4 with gate terminals to which the voltage converted by the load transistors Mp1, Mp2 of the differential input stage 21 is applied, and n-channel MOS transistors Mn3, Mn4 that are connected in series respectively with the MOS transistors Mp3, Mp4. The transistors Mn3, Mn4 form a current mirror circuit. In FIG. 2, symbols of MOS transistors with an outward arrow denote p-channel MOS transistors, and ones with an inward arrow denote n-channel MOS transistors.

The output stage 23 includes an n-channel MOS transistor Mn5 with a gate terminal to which the potential at a connection node N1 between the transistors Mp3 and the Mn3 of the voltage amplifier stage 22, i.e. the drain voltage of the transistor Mp3, is applied, and a constant current source CC2 that is connected to the drain terminal of the transistor Mn5. A source terminal of the transistor Mn5 is connected to a ground point. That is, the constant current source CC2 and the transistor Mn5 are connected in series between the power supply voltage VDD and the ground point. The potential at a connection node N2 between the constant current source CC2 and the MOS transistor Mn5, i.e. the drain voltage of the transistor Mn5, is applied to the gate terminal of the output controlling transistor Q1 so that the output controlling transistor Q1 is controlled.

In the example, a phase compensator circuit 24, which is constituted by a resistor R3 and a capacitor C1 connected in series, is connected between the output terminal OUT and the gate terminal of the p-channel MOS transistor Mp3 of the voltage amplifier stage 22.

The current increasing/decreasing circuit 15 is constituted by a MOS transistor Mp6 as a temperature detector element 15a, and transistors Mn7, Mn8 as a variable current source 15b. In the example, the MOS transistor Mp6 as the temperature detector element 15a is a p-channel MOS transistor having short gate length L and long gate width W, i.e. high W/L ratio.

The gate and drain terminals of the transistor Mp6 are both connected to the voltage input terminal IN so that they are at the same potential. Accordingly, the transistor Mp6 is always in an off-state.

The dimension of the MOS transistor Mp6 is designed such that the gate length is less than that of the transistors Mp1 to Mp4 of the error amplifier 11 (e.g. ¼ to ⅓ of a normal length), and the gate width is greater than that of the Mp1 to Mp4 (e.g. 10 to 20 times of a normal width). In regulator circuits, normal MOS transistors in the circuits such as an error amplifier have a W/L ratio of 0.2 to 6.

The variable current source 15b of the current increasing/decreasing circuit 15 includes an n-channel MOS transistor Mn7 that is connected in series with the p-channel MOS transistor Mp6 as the temperature detector element 15a, and an n-channel MOS transistor Mn8 that is connected to the transistor Mn7 at the respective gates to form a current mirror circuit.

The drain terminal of the n-channel MOS transistor Mn8 is connected to a connection node between the input transistors Mn1, Mn2 and the constant current source CC1 of the differential input stage 21.

In the example, the drain current of the MOS transistor Mp6 as the temperature detector element is directed to the MOS transistor Mn7 and converted to a voltage, which is then applied to the gate terminal of the MOS transistor Mn8. As a result, a current that corresponds to the size ratio between the transistors Mn7 and Mn8 flows to the transistor Mn8. That is, the transistor Mn8 extracts the current from the differential input stage 21.

As is known well in the art, a MOS transistor having short gate length and long gate width is characterized by having an off-state current at high temperature of greater than the off-state current of normal MOS transistors of circuits. As used herein, an off-state current refers to the drain current that flows through a MOS transistor when the gate terminal and the drain terminal of the transistor are at the same potential, i.e. the transistor is in apparently an off state.

In the current increasing/decreasing circuit 15 as described above, the drain current of the MOS transistor Mp6 as the temperature detector element increases as the chip temperature increases, and the current flowing to the MOS transistor Mn7 increases accordingly.

On the other hand, the drain current of the MOS transistor Mn7 is amplified by the current mirror circuit composed of the transistors Mn7 and Mn8 corresponding to the size ratio between the transistors Mn7 and Mn8 while it is hardly affected by the temperature. Thus, a large drain current flows through the Mn8. Therefore, as the chip temperature increases, the current extracted from the differential input stage 21 by the transistor Mn8 increases. That is, the bias current of the differential input stage 21 increases. As a result, the phase margin of the error amplifier 11 at high temperature can be improved without changing the constant of the elements of the phase compensator circuit 24 so that the circuit is less likely to cause oscillation.

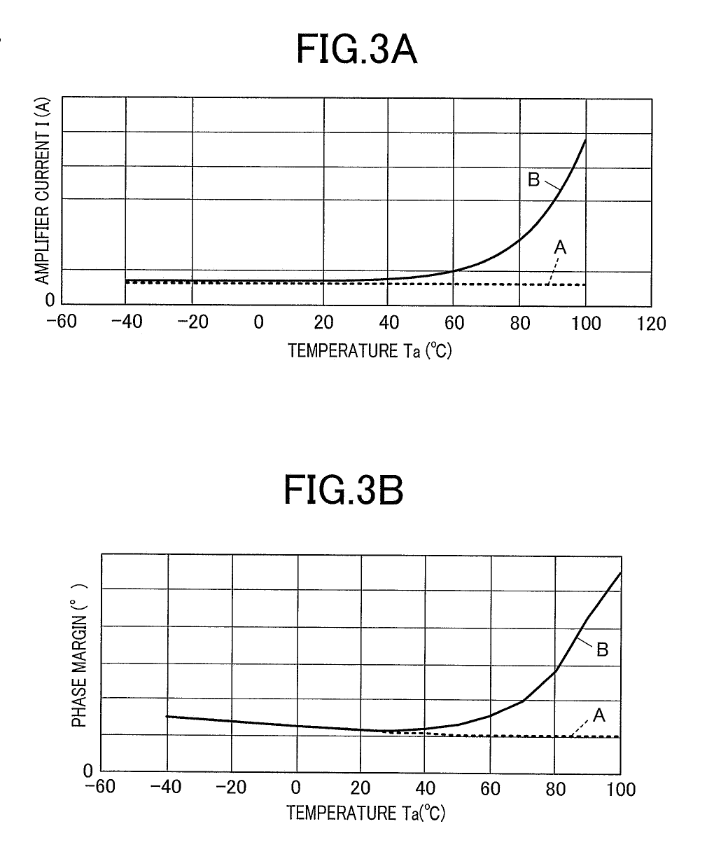

In a circuit simulation conducted by the present inventors, it was found that when the MOS transistor Mn6 has a gate length of 0.7 μm and a gate width of 100 μm, the bias current (amplifier current) of the error amplifier 11 increases with an increase of the chip temperature as illustrated by the solid line B in FIG. 3A, and the phase margin increases accordingly with an increase of the chip temperature as illustrated by the solid line B in FIG. 3B.

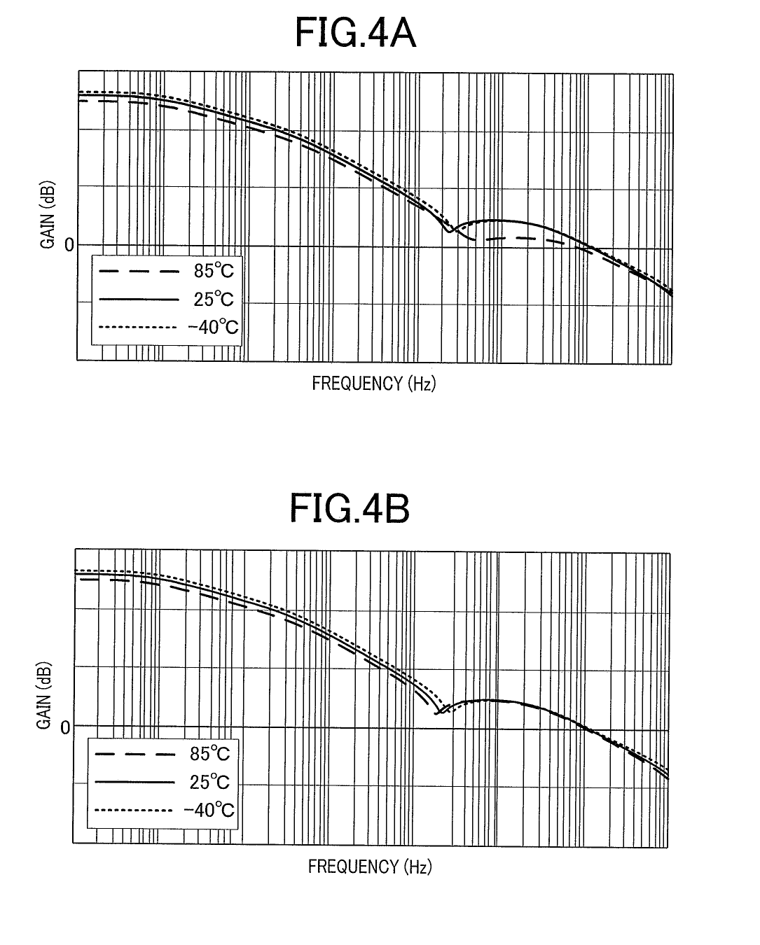

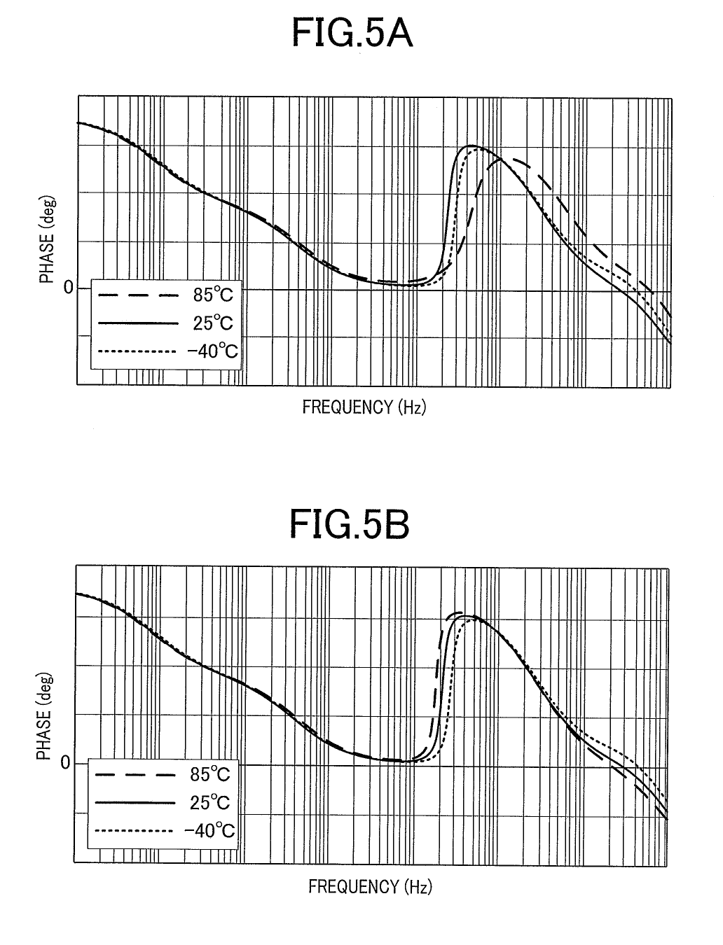

Further, the frequency characteristic of the gain and the phase of the error amplifier 11 was measured and plotted as Bode diagrams. The results are shown in FIG. 4A and FIG. 5A. For comparison, the frequency characteristic of the gain and the phase of an error amplifier without the current increasing/decreasing circuit 15 were also measured. The Bode diagrams thereof are shown in FIG. 4B and FIG. 5B. In FIG. 4A to FIG. 5B, the solid lines represent characteristic at a temperature of 25° C., the dotted lines represent characteristic at a temperature of −40° C., and the dashed lines represent characteristic at a temperature of 85° C.

Comparing FIG. 4A with FIG. 4B, it can be seen from FIG. 4B that the frequency characteristic of the gain of the error amplifier with no current increasing/decreasing circuit 15 does not change very much even when the temperature changes. In contrast, the extremum frequency P of the gain of the error amplifier of the example with the current increasing/decreasing circuit 15 is shifted to a higher frequency when the temperature is 85° C.

Comparing FIG. 5A with FIG. 5B, the frequency characteristic of the phase of the error amplifier with no current increasing/decreasing circuit 15 does not change very much even when the temperature changes. In contrast, the extremum in a high frequency range of the phase characteristic of the error amplifier of the example with the current increasing/decreasing circuit 15 is shifted to a higher frequency. With this characteristic, the error amplifier of the example can improve the phase margin at high temperature.

### Variation

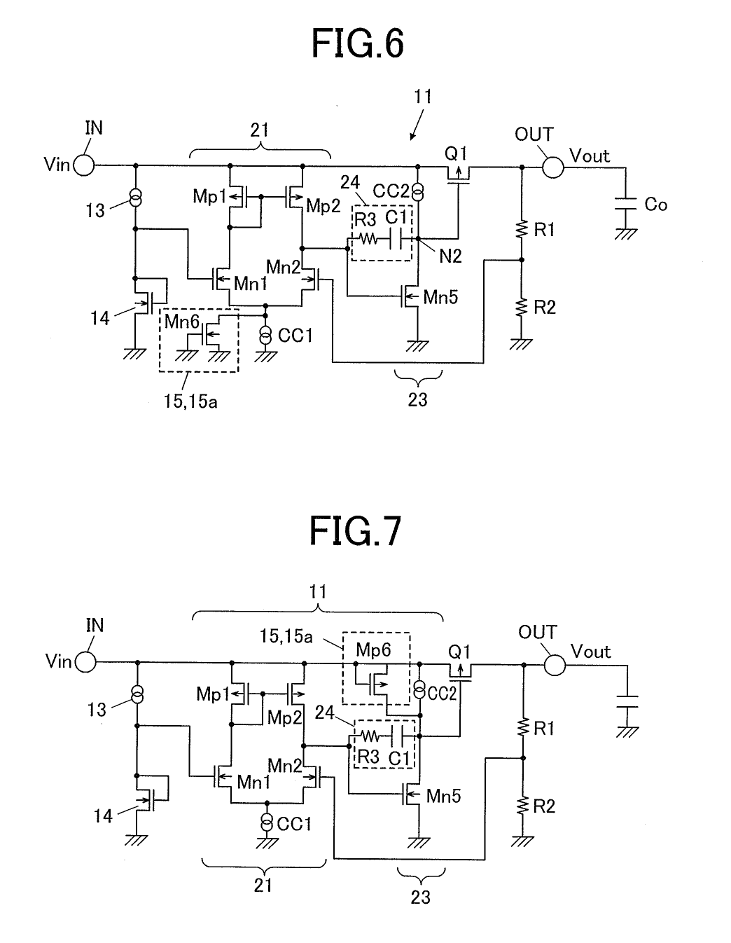

Next, variations of the regulator circuit of the embodiment will be described with FIG. 6 to FIG. 9. In FIG. 6 to FIG. 8, elements and circuits having the same functions as those in FIG. 2 are denoted by the same reference signs.

In a first variation, the current increasing/decreasing circuit 15 is constituted only by the n-channel MOS transistor Mn6 as the temperature detector element 15a as illustrated in FIG. 6, which has high W/L ratio and which has the gate terminal and the source terminal both connected to the ground point so that the transistor is always in an off state.

The drain terminal of the transistor Mn6 is connected to the common sources of the input transistors Mn1, Mn2 of the differential input stage 21.

In the regulator circuit of the first variation, as the chip temperature increases, the drain current of the MOS transistor Mn6 increases, This increases the current extracted from the differential input stage 21, and the bias current of the differential input stage 21 increases accordingly. As a result, the extremum of the gain of the differential input stage 21 is shifted to a higher frequency so that the phase margin is increased.

In the first variation, the voltage amplifier stage is not present, and the gate terminal of the MOS transistor Mn5 of the output stage 23 is connected to the output node of the differential input stage 21. Further, the phase compensator circuit 24, which is constituted by the resistor R3 and the capacitor C1, is connected between the output node of the differential input stage 21 and the output node (gate terminal of the transistor Q1) of the output stage 23. This variation is also applicable to a regulator circuit with the voltage amplifier stage 22 as in FIG. 2.

In a second variation, the current increasing/decreasing circuit 15 is constituted only by the p-channel MOS transistor Mp6 as the temperature detector element 15a as illustrated in FIG. 7, which has high W/L ratio and which has the gate terminal and the drain terminal both connected to the ground point so that the transistor is always in an off state. The drain terminal of the transistor Mp6 is connected to the connection node between the constant current source CC2 and the transistor Mn5 of the output stage 23.

In the regulator circuit of the second variation, as the chip temperature increases, the drain current of the MOS transistor Mp6 increases. This increases the current flowing to the transistor Mn5. That is, the current of the constant current source CC2 is apparently increased. As a result, the extremum of the gain of the output stage is shifted to a higher frequency so that the phase margin is increased.

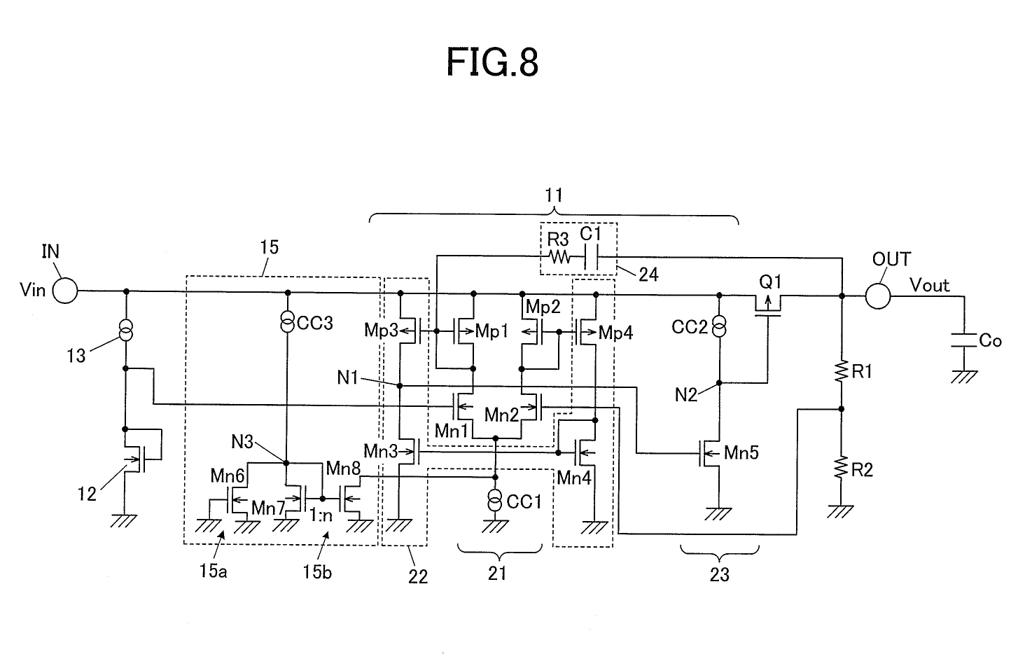

In a third variation, the temperature detector circuit 15a of the current increasing/decreasing circuit 15 is constituted by the n-channel MOS transistor Mn6 as illustrated in FIG. 8, which has high W/L ratio and which has the gate terminal and the source terminal both connected to the ground point so that the transistor is always in an off state.

Further, the variable current source 15b of the current increasing/decreasing circuit 15 is constituted by a constant current source CC3, the n-channel MOS transistor Mn7 connected in series with the constant current source CC3, and the n-channel MOS transistor Mn8 that is connected to the transistor Mn7 at the respective gate terminals to form a current mirror circuit.

The drain terminal of the MOS transistor Mn6 of the temperature detector circuit 15a is connected to a connection node N3 between the constant current source CC3 and the n-channel MOS transistor Mn7. The drain terminal of the n-channel MOS transistor Mn8 that together with the transistor Mn7 forms the current mirror circuit is connected to the connection node between the input transistors Mn1, Mn2 and the constant current source CC1 of the differential input stage 21. The other configuration is the same as that of the example in FIG. 2.

In this variation, as the chip temperature increases, the drain current of the MOS transistor Mn6 increases. This decreases the current flowing to the n-channel MOS transistor Mn7 connected in series with the constant current source CC3h. Accordingly, the current extracted from the differential input stage 21 decreases, and the bias current of the differential input stage 21 decreases. That is, this variation is configured such that the bias current of the differential input stage 21 decreases at high temperature.

Specifically, when the temperature is higher than a certain value Tc (e.g. 20° C.), all the current from the constant current source CC3 flows to the MOS transistor Mn7. When the temperature falls below Tc, a current starts to flow through the MOS transistor Mn7. This increases the current extracted from the differential input stage 21, and the bias current of the differential input stage 21 increases accordingly.

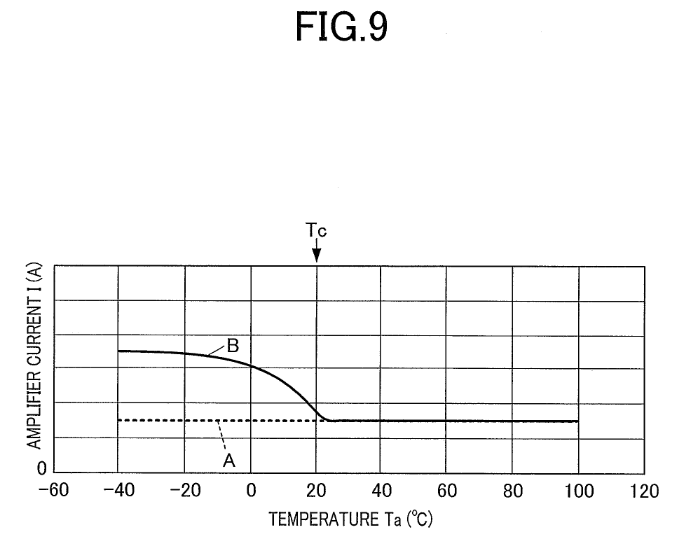

In FIG. 9, the solid line B represents the temperature characteristic of the bias current of the error amplifier of the regulator circuit according to the third variation. The dashed line A represents the temperature characteristic of the bias current when the current increasing/decreasing circuit 15 is not present. As can be seen from FIG. 9, in the third variation, the bias current of the error amplifier increases as the temperature decreases. This shifts the extremum of the gain of the error amplifier to a higher frequency at low temperature, and the phase margin can thereby be improved.

Comparing the circuits of FIG. 2 and FIG. 8, their error amplifiers have the same circuit configuration. However, depending on the setting of the C-R time constant of the phase compensator circuit 24, the phase margin sometimes decreases as the temperature decreases. In such cases, this variation is useful since it is favorable to increase the bias current of the error amplifier as the temperature decreases.

Next, an example of an applied system to which the regulator circuit of the example or any of the variations is suitably applied will be described.

In recent years, monitoring systems and information gathering systems using IoT techniques have become popular, and a variety of IoT-related sensors have been proposed. Further, such IoT-related sensors, communication devices that gather information from various IoT-related sensors and send it to an end user computer or a server via a network, and systems that allow controlling devices with a communicating function through applications installed in portable terminals such as smartphones and that receive information from devices such as electronic tags to provide various services so as to improve the convenience have been put into practice.

A power supply composed of a battery and a regulator circuit is used in many instruments and devices of such systems. Conventional regulator circuits with MOS transistors may sometimes suffer from a decrease of the phase margin of the control loop when the environmental temperature changes, which may result in oscillation of the circuit. In contrast, the regulator circuit of the example or any of the variations can reduce the occurrence of oscillation. Therefore, power supplies using the regulator circuit of the example or any of the variations can be very useful for such systems.

While the invention made by the present inventors is specifically described with examples, the present invention is not limited to the above-described examples. For example, in the embodiment, a MOS transistor having high W/L ratio is used as the temperature detector element. However, the temperature detector element is not limited to such transistors and may be constituted by a different element such as a resistor having a temperature characteristic.

In the above-described embodiment, all the transistors in the IC are MOS transistors. However, the output controlling transistor may be a bipolar transistor while the transistors of the other circuits including the error amplifier in the regulator circuit are MOS transistors.

The circuit elements except for the output controlling transistor may be configured as an IC, and the output controlling transistor as an external element may be connected to the IC. They may be then incorporated in a single package of a semiconductor device.

In the above-described example, the present invention is applied to a regulator circuit. However, the present invention is broadly applicable to general semiconductor integrated circuits with a differential amplifier circuit.

What is claimed is:

1. A regulator circuit, comprising:
an output controlling transistor which is connected between a voltage input terminal to which a DC voltage is input and an output terminal; and
a controller circuit comprising an error amplifier circuit which controls the output controlling transistor according to an output feedback voltage,
wherein the error amplifier circuit comprises:
a differential input stage which comprises a pair of input transistors and a current source for supplying a current to the input transistors;
an output stage which comprises a current source and a transistor connected in series with the current source and which amplifies a potential at one output node of the differential input stage; and
a current increasing/decreasing circuit which increases or decreases a current of the differential input stage or a current of the output stage, and
wherein the current increasing/decreasing circuit comprises an element having a temperature characteristic, and increases or decreases the current of the differential input stage or the current of the output stage according to the temperature characteristic of the element.

2. The regulator circuit according to claim 1, wherein the element having the temperature characteristic is constituted by a MOS transistor having a ratio of gate width to gate length at least 10 times greater than a MOS transistor of the error amplifier circuit.

3. The regulator circuit according to claim 2,
wherein the element having the temperature characteristic is constituted by a first conductive-type MOS transistor with a gate terminal and a source terminal connected to each other,
wherein the current increasing/decreasing circuit comprises:
a second type-conductive MOS transistor which is connected in series with the first conductive-type MOS transistor; and
a MOS transistor which is connected with the second conductive-type transistor in a current mirror manner to flow a mirrored current proportional to an element size, and
wherein the MOS transistor which flows the mirrored current is connected in parallel to the current source of the differential input stage so as to increase/decrease the current of the differential input stage.

4. The regulator circuit according to claim 3,
wherein the error amplifier circuit further comprises a voltage amplifier stage which amplifies a differential output of the differential input stage, and
wherein the output stage is connected in such a manner to amplify a potential at one output node of the voltage amplifier stage.

5. The regulator circuit according to claim 2, wherein the MOS transistor of the element having the temperature characteristic is connected in parallel to the current source of the differential input stage or the current source of the output stage so as to increase/decrease the current of the differential input stage or the current of the output stage.

6. The regulator circuit according to claim 1, used for an IoT-related sensor or a device in a network including an IoT-related sensor.

7. A semiconductor device in which the regulator circuit according to claim 1 is incorporated in a single package.

8. A power supply, comprising the regulator circuit according to claim 1.
